(19) United States
(12) Patent Application Publication
(10) Pub. No.: US 2011/0247593 A1
(43) Pub. Date: Oct. 13, 2011

(54) CONTROL APPARATUS FOR INTERNAL COMBUSTION ENGINE

(75) Inventors: Satoshi Yoshizaki, Gotenba-shi (JP); Yasuyuki Irisawa, Susono-shi (JP); Shinichi Mitani, Susono-shi (JP); Takashi Tsunooka, Gotenba-shi (JP); Akira Satou, Gotenba-shi (JP); Shigeyuki Urano, Susono-shi (JP)

(73) Assignee: Toyota Jidosha Kabushiki Kaisha, Toyota-Shi (JP)

(21) Appl. No.: 13/082,703

(22) Filed: Apr. 8, 2011

(30) Foreign Application Priority Data
Apr. 8, 2010 (JP) JP2010-089574

(51) Int. Cl. F02M 33/02

(52) U.S. Cl. 123/520

(57) ABSTRACT

A control apparatus for an internal combustion engine includes a fuel tank; a vaporized fuel tank that is connected to an intake passage; an in-tank fuel supplying portion that supplies fuel in the fuel tank to the vaporized fuel tank; a vaporized fuel supply valve that opens and closes a connecting portion between the vaporized fuel tank and the intake passage; an air introduction valve provided in the vaporized fuel tank; a throttle valve; a vaporized fuel producing portion that produces vaporized fuel in the vaporized fuel tank; a vaporized fuel supplying portion that supplies vaporized fuel stored in the vaporized fuel tank; and a supply amount controlling portion that controls a supply amount of vaporized fuel according to an opening amount of the throttle valve by driving the throttle valve when supplying vaporized fuel.

### CROSS-REFERENCE TO RELATED APPLICATIONS

This application claims priority to Japanese Patent Application No. 2010-089574 filed on Apr. 8, 2010, which is incorporated herein by reference in its entirety including the specification, drawings and abstract.

### BACKGROUND OF THE INVENTION

1. Field of the Invention

The invention relates to a control apparatus for an internal combustion engine that uses low volatile fuel such as alcohol fuel, for example.

2. Description of the Related Art Japanese Patent Application Publication No. 2007-224878 (JP-A-2007-224878) describes a control apparatus for an internal combustion engine that uses alcohol fuel. Alcohol fuel does not easily vaporize particularly at low temperatures, so a vaporizing chamber to vaporize the fuel at startup is provided in an internal combustion engine. This vaporizing chamber has a closed structure in which it is cut off from the outside, and is connected to an intake passage via a reduced passage. Also, a startup fuel injection valve that injects fuel into the vaporizing chamber, and a heater for heating the injected fuel are both provided in the vaporizing chamber.

At startup of the internal combustion engine, the heater is first activated when a start signal is output to the internal combustion engine. Then when an appropriate amount of time has passed, fuel is injected into the vaporizing chamber from the startup fuel injection valve. When fuel is injected, the pressure in the vaporizing chamber becomes reduced due to the effect of intake negative pressure produced by cranking. As a result, the injected fuel vaporizes from the heat of the heater in the reduced-pressure vaporizing chamber, and is supplied to the cylinders via the intake passage. In this way, the related art ensures startability during a cold-start, for example, by vaporizing the fuel in the vaporizing chamber at startup.

Incidentally, with the technology described in JP-A-2007-224878, vaporized fuel is produced by injecting fuel into the vaporizing chamber after activating the heater at startup. However, in this case, after the start signal is output to the internal combustion engine, the temperature of the heater rises, the injected fuel is heated, and the pressure in the vaporizing chamber is reduced, and as a result, vaporized fuel is produced. Therefore, with the technology described above, it takes time to produce vaporized fuel at startup, so vaporized fuel is unable to be immediately supplied into the cylinders.

### SUMMARY OF THE INVENTION

The invention thus provides a control apparatus for an internal combustion engine, that is capable of immediately supplying vaporized fuel into the cylinders, and thus improve startability, even under conditions in which fuel does not easily vaporize, such as during a cold start.

A first aspect of the invention relates to a control apparatus for an internal combustion engine. This control apparatus includes a fuel tank in which fuel is stored; a fuel injection valve that injects fuel in the fuel tank into an intake passage and/or a combustion chamber; a vaporized fuel tank that is connected to the intake passage and in which vaporized fuel that is the fuel that has been vaporized is stored; an in-tank fuel supplying portion that supplies fuel in the fuel tank to the vaporized fuel tank; a normally-closed vaporized fuel supply valve that opens and closes a connecting portion between the vaporized fuel tank and the intake passage; a normally-closed air introduction valve that introduces ambient air into the vaporized fuel tank and is provided in a position that enables the inside of the vaporized fuel tank to be communicated with a space outside the vaporized fuel tank; a throttle valve that is provided in the intake passage upstream of the vaporized fuel supply valve and adjusts a flow path area of the intake passage; a vaporized fuel producing portion that produces vaporized fuel in the vaporized fuel tank by driving the in-tank fuel supplying portion while the vaporized fuel supply valve and the air introduction valve are closed, while the internal combustion engine is operating; a vaporized fuel supplying portion that supplies vaporized fuel stored in the vaporized fuel tank while the internal combustion engine is operating to the intake passage by opening the vaporized fuel supply valve and the air introduction valve at startup of the internal combustion engine; and a supply amount controlling portion that controls a supply amount of vaporized fuel according to an opening amount of the throttle valve by driving the throttle valve when supplying vaporized fuel.

According to this control apparatus, vaporized fuel can be produced while the internal combustion engine is operating, and this vaporized fuel can be stored in a vaporized fuel tank using the natural decrease in pressure after the engine stops. Accordingly, it is not necessary to produce vaporized fuel at startup, so vaporized fuel can be immediately supplied into the cylinders even during a cold start. Also, when vaporized fuel is supplied, the throttle valve is driven and the amount of vaporized fuel that is supplied (i.e., the flow rate of vaporized fuel) can be controlled according to the throttle opening amount. As a result, startability can be ensured, while the amount of vaporized fuel that is consumed can be appropriately suppressed. Therefore, the amount of vaporized fuel supplied can be smoothly controlled using the existing throttle valve even when simple two-position switching type electromagnetic valves, for example, are used for the vaporized fuel supply valve and the air introduction valve. That is, the cost of the system can be reduced while performance can be improved.

A second aspect of the invention relates to a control apparatus for an internal combustion engine system. This control apparatus includes a fuel tank in which fuel is stored; a vaporized fuel tank that is supplied with fuel from the fuel tank; a fuel supplying portion that supplies fuel in the fuel tank to the vaporized fuel tank; an intake passage that is a passage that supplies a mixture of fuel and air to an internal combustion engine, and that is connected to the vaporized fuel tank; a vaporized fuel supply valve that opens and closes communication between the vaporized fuel tank and the intake passage; an air introduction valve that introduces ambient air into the vaporized fuel tank and is provided in a position that enables the inside of the vaporized fuel tank to be communicated with a space outside the vaporized fuel tank; a throttle valve that is provided in the intake passage upstream of the vaporized fuel supply valve and adjusts a flow path area of the intake passage; a vaporized fuel producing portion that produces vaporized fuel in the vaporized fuel tank by operating the fuel supplying portion while the vaporized fuel supply valve and the air introduction valve are closed, while the internal combustion engine is operating; a vaporized fuel supplying portion that supplies vaporized fuel stored in the vaporized fuel tank while the internal combustion engine is operating to the intake passage by opening the vaporized fuel supply valve and the air introduction valve at startup of the internal combustion engine; and a supply amount controlling portion that controls a supply amount of vaporized fuel according to an opening amount of the throttle valve by driving the throttle valve when supplying vaporized fuel.

A third aspect of the invention relates to a control method for an internal combustion engine system. Here, the internal combustion engine system includes a fuel tank in which fuel is stored; a vaporized fuel tank that is supplied with fuel from the fuel tank; a fuel supplying portion that supplies fuel in the fuel tank to the vaporized fuel tank; an intake passage that is a passage that supplies a mixture of fuel and air to an internal combustion engine, and that is connected to the vaporized fuel tank; a vaporized fuel supply valve that opens and closes communication between the vaporized fuel tank and the intake passage; an air introduction valve that introduces ambient air into the vaporized fuel tank and is provided in a position that enables the inside of the vaporized fuel tank to be communicated with a space outside the vaporized fuel tank; and a throttle valve that is provided in the intake passage upstream of the vaporized fuel supply valve and adjusts a flow path area of the intake passage. The control method for this internal combustion engine system includes producing vaporized fuel in the vaporized fuel tank by operating the fuel supplying portion while the vaporized fuel supply valve and the air introduction valve are closed, while the internal combustion engine is operating; supplying vaporized fuel stored in the vaporized fuel tank while the internal combustion engine is operating to the intake passage by opening the vaporized fuel supply valve and the air introduction valve at startup of the internal combustion engine; and controlling a supply amount of vaporized fuel according to an opening amount of the throttle valve by driving the throttle valve when supplying vaporized fuel.

### BRIEF DESCRIPTION OF DRAWINGS

The foregoing and further features and advantages of the invention will become apparent from the following description of example embodiments with reference to the accompanying drawings, wherein like numerals are used to represent like elements and wherein:

FIG. 1 is an overall block diagram of a system configuration according to a first example embodiment of the invention;

FIG. 2 is a block diagram of a control system of the system in the first example embodiment of the invention;

FIG. 3 is a characteristic line graph showing the relationship between the coolant temperature at startup and the startup required flow rate of vaporized fuel;

FIG. 4 is a characteristic line graph showing the relationship between the supply flow rate of the vaporized fuel and the throttle opening amount;

FIG. 5 is a flowchart illustrating vaporized fuel production control executed by an ECU, in the first example embodiment of the invention;

FIG. 6 is a flowchart illustrating vaporized fuel supply control executed by the ECU, in the first example embodiment of the invention;

FIG. 7 is a characteristic line graph showing the relationship between the throttle opening amount and the phase of an intake valve, in a second example embodiment of the invention;

FIG. 8 is a characteristic line graph showing the relationship between the throttle opening amount and the operation angle of the intake valve in the second example embodiment of the invention; and

FIG. 9 is a flowchart illustrating vaporized fuel supply control executed by the ECU, in the second example embodiment of the invention.

### DETAILED DESCRIPTION OF EMBODIMENTS

### First Example Embodiment

[Structure of the First Example Embodiment]

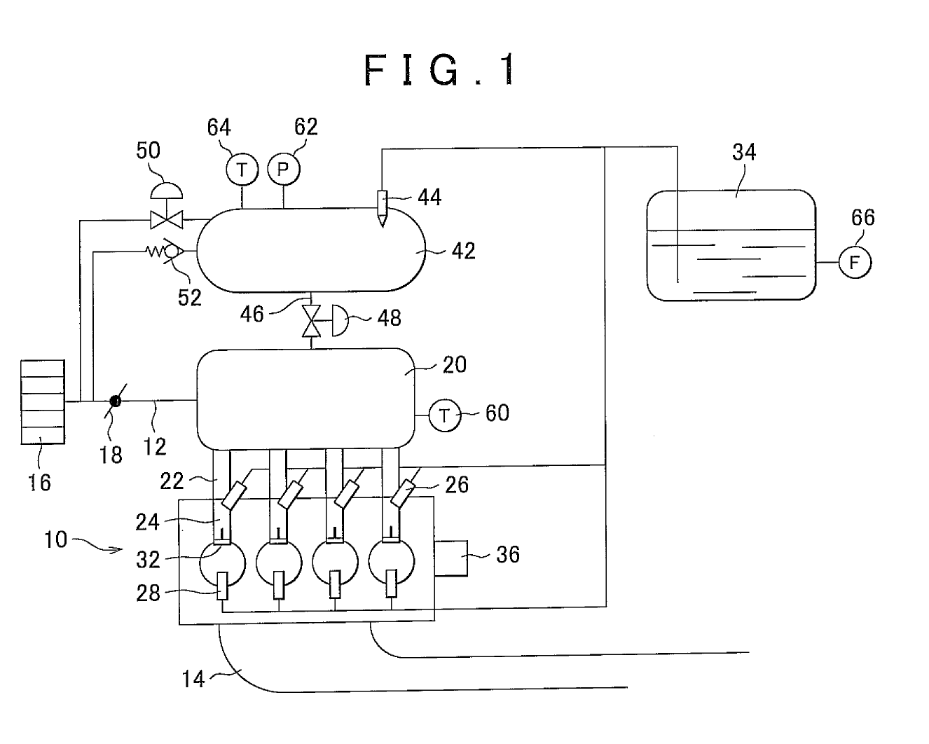

Hereinafter, a first example embodiment of the invention will be described with reference to FIGS. 1 to 6. FIG. 1 is an overall block diagram of a system configuration according to the first example embodiment of the invention. The system in this example embodiment includes an engine 10 as an internal combustion engine mounted in a FFV (Flexible Fuel Vehicle). Incidentally, a four cylinder engine is shown in FIG. 1, but the invention is not limited to a four cylinder internal combustion engine. The engine 10 includes an intake passage 12 through which air is drawn into combustion chambers of cylinders, and an exhaust passage 14 through which exhaust gas is discharged from the combustion chambers.

An air cleaner 16, a throttle valve 18, and a surge tank 20 are provided in order from the upstream side in the intake passage 12. The throttle valve 18 is formed by an electronically controlled butterfly valve. The throttle valve 18 is opened and closed between a fully-closed position and a wide-open position by an ECU 70 that will be described later, and adjusts the flow passage area of the intake passage 12, and thus regulates the intake air amount, according to the opening amount (i.e., the throttle opening amount). The surge tank 20 forms a space of a certain area midway in the intake passage 12 in order to attenuate intake pulsation. The downstream side of the surge tank 20 is connected to an intake port 24 of each cylinder via an intake manifold 22 formed of a plurality of intake pipes. Incidentally, the surge tank 20, the intake manifold 22, and the intake port 24 form part of the intake passage 12.

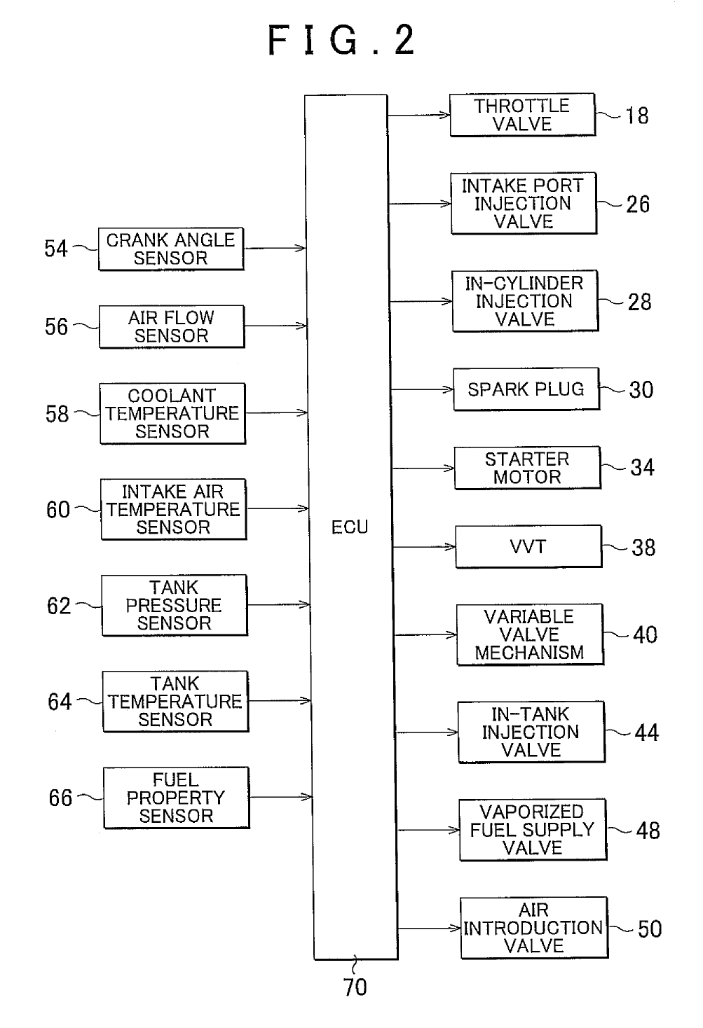

Further, an intake port injection valve 26 that injects fuel into the intake port 24 and an in-cylinder injection valve 28 that injects fuel directly into the combustion chamber (i.e., into the cylinder) are provided for each cylinder of the engine 10. These injection valves 26 and 28 are formed by typical electromagnetically driven fuel injection valves. Furthermore, a spark plug 30 (see FIG. 2) that ignites an air-fuel mixture that flows into the cylinder, an intake valve 32 that opens and closes the intake port 24, and an exhaust valve (not shown) that opens and closes an exhaust port are all provided for each cylinder. Also, alcohol fuel stored in a liquid state in a fuel tank 34 of the vehicle is supplied by a fuel pump or the like to the injection valves 26 and 28 described above.

Also, the engine 10 includes a starter motor 36 that rotatably drives a crankshaft at startup. When a driver of the vehicle turns a starter switch on, an engine start command is output to the ECU 70. As a result, the ECU 70 operates the starter motor 36 to rotate the crankshaft (i.e., perform cranking). Then when the engine has started, i.e., when the engine starts to operate under its own power, cranking is stopped.

Moreover, the engine 10 includes a VVT (Variable Valve Timing system) 38 and a variable valve mechanism 40, as shown in FIG. 2 that will be described later. These may be regarded as the variable intake valve portion of the invention. The VVT 38 variably sets the phase of the intake valve 32, and the variable valve mechanism 40 variably sets the operation angle (i.e., valve open period) and the lift amount of the intake valve 32. In describing the structure of these devices, the valve system of the intake valve 32 will be described first. The valve system includes a camshaft provided with an intake cam, and a timing pulley provided on this camshaft. The timing pulley is connected to the crankshaft of the engine 10 via a timing chain. Therefore, while the engine is operating, rotation of the crankshaft is transmitted to the timing pulley via the timing chain, and the camshaft (i.e., the intake cam) is rotatably driven by the timing pulley. As a result, input from the intake cam is transmitted to the intake valve 32 via a rocker arm, such that the intake valve 32 opens and closes at a predetermined timing according to the rotation angle of the camshaft.

In the valve system structured in this way, the VVT 38 has a known structure such as that described in Japanese Patent Application Publication No. 2000-87769 (JP-A-2000-87769), for example. That is, the VVT 38 includes an actuator that relatively rotates the camshaft and the timing pulley. The VVT 38 is able to variably set the phase of the intake valve 32 according to the relative rotation angles of these two. Meanwhile, the variable valve mechanism 40 has a known structure such as that described in Japanese Patent Application Publication No. 2007-107404 (JP-A-2007-107404), for example. That is, the variable valve mechanism 40 has two pivoting members interposed between the intake cam and the rocker arm, and an actuator that changes the relative positions of these pivoting members. Input from the intake cam is transmitted to the rocker arm via these pivoting members, but the transmission amount and the timing of that transmission change according to the relative positions of the pivoting members. As a result, the variable valve mechanism 40 is able to increase the operation angle of the intake valve 32 by retarding the valve closing timing (IVC) while advancing the valve opening timing (IVO) of the intake valve 32. Also, the variable valve mechanism 40 is able to decrease the operation angle of the intake valve 32 by advancing the IVC while retarding the IVO. Incidentally, the VVT 38 and the variable valve mechanism 40 are used with control according to a second example embodiment that will be described later. Therefore, in the invention, the VVT 38 and the variable valve mechanism 40 may be omitted, i.e., not be installed in the engine, when only the control of the first example embodiment is performed.

Next, a fuel vaporizing system installed in the engine 10 will be described. In this example embodiment, vaporized fuel produced while the engine is operating is stored in a tank, and this vaporized fuel is used at startup the next time the engine 10 is started. The fuel vaporizing system includes a vaporized fuel tank 42, an in-tank injection valve 44, a vaporized fuel supply valve 48, an air introduction valve 50, and a relief valve 52, and the like that will be described below.

The vaporized fuel tank 42 is formed as a pressure tight case having a closed structure, and is made to store vaporized fuel that is the alcohol fuel in the fuel tank 34 after it has been vaporized. Also, the vaporized fuel tank 42 is arranged in a location within the engine compartment to where heat from the engine 10 can easily be conducted, for example. The in-tank injection valve 44 injects (i.e., supplies) fuel stored in the fuel tank 34 into the vaporized fuel tank 42, and may be regarded as the in-tank fuel supply portion of the invention. The in-tank injection valve 44 is formed by a typical fuel injection valve similar to the injection valves 26 and 28, for example. The fuel injection quantity from the in-tank injection valve 44 is controlled according to a control signal. The fuel injected from the in-tank injection valve 44 is vaporized in the vaporized fuel tank 42 and thus becomes vaporized fuel.

The vaporized fuel tank 42 is connected to the surge tank 20 via a fuel supply line 46. This connecting portion is set on the downstream side of the throttle valve 18 in the intake passage 12. A vaporized fuel supply valve 48 formed by a normally-closed electromagnetic valve or the like is provided in the fuel supply line 46. When the vaporized fuel supply valve 48 is closed, communication between the vaporized fuel tank 42 and the surge tank 20 is cutoff, such that vaporized fuel is able to be stored in the vaporized fuel tank 42. Also, when the vaporized fuel supply valve 48 is open, the vaporized fuel tank 42 is communicated with the surge tank 20 via the fuel supply line 46, such that vaporized fuel stored in the vaporized fuel tank 42 is supplied to the surge tank 20.

Also, the air introduction valve 50 is provided in the vaporized fuel tank 42 in a location that allows communication between the inside of the tank and a space outside the tank. The air introduction valve 50 is formed by a normally-closed electromagnetic valve or the like, which when closed, opens the vaporized fuel tank 42 to ambient air. When vaporized fuel is supplied, both the vaporized fuel supply valve 48 and the air introduction valve 50 are opened at slightly different timings, such that ambient air of an amount corresponding to the amount of vaporized fuel that is supplied is introduced into the vaporized fuel tank 42 through the air introduction valve 50 valve. Incidentally, these valves 48 and 50 are kept closed except for when vaporized fuel is supplied. Also, the air introduction valve 50 is connected to the intake passage 12 between the air cleaner 16 and the throttle valve 18. Therefore, when the air introduction valve 50 is open, air that has been cleaned by the air cleaner 16 and that is unaffected by intake negative pressure is introduced into the vaporized fuel tank 42.

Moreover, a normally-closed relief valve 52 that is formed by a check valve or a reed valve or the like, for example, is provided in the vaporized fuel tank 42. When the pressure inside the vaporized fuel tank 42 exceeds a predetermined operating pressure, the relief valve 52 releases this pressure outside (e.g., into the intake passage 12). The operating pressure of this relief valve 52 is set to a pressure that is approximately the same as atmospheric pressure or to a high pressure that is approximately several tens of kPa higher than atmospheric pressure, for example. This setting presumes, for example, that the vaporized fuel tank 42 is maintained at approximately room (i.e., normal) temperature or a temperature slightly higher than room temperature, and that the saturated vapor pressure of the fuel is a pressure that corresponds to this temperature range. As a result, when the fuel injected into the vaporized fuel tank 42 vaporizes, the relief valve 52 allows the air inside the tank to escape to the outside. Also, the relief valve 52 also functions as a safety valve that prevents the pressure inside that tank from becoming excessive while the vaporized fuel tank 42 is closed.

Next, the control system of the engine 10 will be described with reference to FIG. 2. FIG. 2 is a block diagram of the control system of the system in the first example embodiment of the invention. As shown in the drawing, the system of this example embodiment includes a sensor system that includes a plurality of sensors 54 to 66, and an ECU (Electronic Control Unit) 70 that controls the operating state of the engine 10.

First, the sensor system will be described. A crank angle sensor 54 outputs a signal in synchronization with the rotation of the crankshaft of the engine 10. The ECU 70 detects the crank angle and the engine speed based on this output. Also, an air flow sensor 56 detects the intake air amount, a coolant temperature sensor 58 detects the coolant temperature of the engine, and an intake air temperature sensor 60 detects the temperature of the intake air. Meanwhile, a tank pressure sensor 62 detects the pressure inside the vaporized fuel tank 42, a tank temperature sensor 64 detects the temperature inside the vaporized fuel tank 42, and a fuel property sensor 66 detects the alcohol concentration in the fuel as the property of the fuel.

In addition to the sensors 54 to 66 described above, the sensor system also includes a variety of other sensors necessary to control the vehicle and the engine (such as an air-fuel ratio sensor that detects the exhaust gas air-fuel ratio, a throttle sensor that detects the throttle opening amount, and an accelerator operation amount sensor that detects the accelerator operation amount, and the like). These sensors are all connected to the input side of the ECU 70. Incidentally, the invention does not necessarily require the tank temperature sensor 64. That is, the tank temperature sensor 64 may be omitted, and the tank internal temperature may instead be estimated based on the temperature and operating history of the engine, and the conduction characteristic of heat to the vaporized fuel tank 42, and the like.

Meanwhile, various actuators, including the throttle valve 18, the injection valves 26, 28, and 44, the spark plug 30, the starter motor 36, the VVT 38, the variable valve mechanism 40, the vaporized fuel supply valve 48, and the air introduction valve 50, and the like are connected to the output side of the ECU 70. The ECU 70 detects the information about the operation of the engine from this sensor system, and performs operation control by driving the actuators based on the detection results. More specifically, the ECU 70 detects the crank angle and the engine speed based on the output from the crank angle sensor 54, and detects the intake air amount from the air flow sensor 56. Also, the ECU 70 determines the firing timing and drives the spark plug 30 based on the crank angle, while performing normal fuel injection control that will be described below.

Normal fuel injection control is executed while the engine 10 is operating, except for when vaporized fuel supply control that will be described below is executed, and also includes startup fuel injection control. In this fuel injection control, the ECU 70 first calculates a fuel injection quantity based on the intake air amount, the engine speed, and the temperature of the engine coolant and the like, and determines the fuel injection timing based on the crank angle, and then drives one or both injection valves 26 and 28. In this case, the ratio of the injection quantity from the intake port injection valve 26 and the in-cylinder injection valve 28 is variably set according to the property of the fuel and the operating state of the engine. Further, the ECU 70 executes vaporized fuel production control that will be described next, and vaporized fuel supply control as controls of the fuel vaporizing system.

[Operation of the First Example Embodiment]

(Vaporized Fuel Production Control)

Vaporized fuel production control is control that produces vaporized fuel by vaporizing fuel in the vaporized fuel tank 42 while the engine 10 is operating (preferably while the engine 10 is operating after having warmed up completely). More specifically, in vaporized fuel production control, fuel is injected from the in-tank injection valve 44 while the vaporized fuel supply valve 48 and the air introduction valve 50 are both closed. At this time, the fuel injection quantity is calculated such that all of the injected fuel is vaporized and the vapor pressure of the vaporized fuel becomes the saturated vapor pressure.

Then, the fuel injected from the in-tank injection valve 44 is immediately vaporized, thus becoming vaporized fuel, while air inside the tank is forced out through the relief valve 52. At this time, the relief valve 52 prevents vaporization of the fuel from being impeded by the air pressure in the tank, thereby promoting the production of vaporized fuel. As a result, once fuel vaporization is complete, almost all of the air inside the tank has been discharged, so the vaporized fuel tank 42 is filled with vaporized fuel at a pressure close to the saturated vapor pressure.

According to the vaporized fuel production control described above, vaporized fuel can be stored in the vaporized fuel tank 42 while the engine is operating. Also, the vaporized fuel tank 42 is such that at least some of the vaporized fuel can be kept in a vapor state even when cold after the engine has stopped, by using the decrease in pressure that naturally occurs inside the tank. Incidentally, the vaporized fuel production control is preferably executed only when the temperature inside the vaporized fuel tank 42 is equal to or greater than a predetermined determining temperature at which vaporized fuel is able to be produced.

(Vaporized Fuel Supply Control)

Vaporized fuel supply control is control that supplies vaporized fuel that has been stored in the vaporized fuel tank 42 to the surge tank 20 by opening both the vaporized fuel supply valve 48 and the air introduction valve 50 when the engine is started. More specifically, the ECU 70 first detects the output of a start command when the starter switch is turned on. Then the ECU 70 operates the starter motor 36 to start cranking while the vaporized fuel supply valve 48 and the air introduction valve 50 are closed. As a result, intake negative pressure is generated in the surge tank 20 as a result of the cranking.

Then once the intake negative pressure in the surge tank 20 has increased sufficiently, the ECU 70 opens the vaporized fuel supply valve 48 and the air introduction valve 50. As a result, the vaporized fuel in the vaporized fuel tank 42 is supplied into the surge tank 20 by the intake negative pressure. At this time, air of an amount corresponding to the amount of vaporized fuel that flows out flows into the vaporized fuel tank 42 through the air introduction valve 50, such that vaporized fuel is supplied smoothly. Also, if the pressure in the vaporized fuel tank 42 is equal to or greater than atmospheric pressure when the vaporized fuel supply valve 48 and the air introduction valve 50 are opened, the vaporized fuel supply valve 48 is opened first. If, on the other hand, the pressure in the vaporized fuel tank 42 is less than atmospheric pressure, the air introduction valve 50 is opened first. As a result, it is possible to prevent vaporized fuel in the tank from flowing out into the atmosphere or air from flowing back into the vaporized fuel tank 42 from the surge tank 20.

Vaporized fuel that has been supplied from the vaporized fuel tank 42 to the surge tank 20 flows into the cylinder via the intake port 24 and is ignited and combusted in the cylinder. Then when it is confirmed that the engine has started by the engine speed rising or the like, the ECU 70 stops the cranking. Also, the ECU 70 closes the vaporized fuel supply valve 48 and the air introduction valve 50 and ends the vaporized fuel supply control. Then the ECU 70 starts normal fuel injection control and injects fuel from the intake port injection valve 26 and the in-cylinder injection valve 28. Incidentally, the switch from vaporized fuel injection to normal fuel injection does not necessarily require that engine startup first be confirmed (i.e., that it first be confirmed that the engine has started). For example, the switch to normal fuel injection may be made when the amount of vaporized fuel required at startup has been supplied. Also, vaporized fuel may be supplied to the cylinders only during the first combustion cycle, and then normal fuel injection control may be executed from the second combustion cycle on.

If vaporized fuel that has been stored while the engine is operating is used in this way, it is not necessary to produce vaporized fuel after a start command has been output. That is, compared to when vaporized fuel is produced at startup, vaporized fuel can be immediately supplied into the cylinders, thus enabling startability to be improved even when starting the engine at low temperatures at which fuel does not easily vaporize. Incidentally, the vaporized fuel supply control is preferably executed only when the engine temperature (e.g., the temperature of the engine coolant, for example) at startup is equal to or less than a predetermined determining temperature that requires vaporized fuel.

Incidentally, when supplying vaporized fuel as described above, the necessary amount of vaporized fuel changes according to the temperature environment (i.e., the outside air temperature and the engine temperature) at startup. Therefore, when designing the system, it is preferable to employ a structure that enables the amount of vaporized fuel that is supplied to be controlled. This structure can be realized by using flow control type advanced electromagnetic valves or the like as the vaporized fuel supply valve 48 and the air introduction valve 50. However, on the other hand, the parts of the system, including these valves 48 and 50, need to be as simple as possible to keep the cost of the parts down.

Therefore, in this example embodiment, the amount of vaporized fuel that is supplied (i.e., the supply flow rate) is controlled by the existing throttle valve 18, and simple two-position switching type electromagnetic valves that only open and close are used for the valves 48 and 50. Also, in this example embodiment, the maximum flow rates of the component parts (i.e., the fuel supply line 46, the vaporized fuel supply valve 48, and the air introduction valve 50) of the gas flow path that affect the supply flow rate of the vaporized fuel are appropriately designed such that the maximum supply flow rate necessary at startup can be realized.

(Supply Flow Rate Control)

When vaporized fuel is supplied, vaporized fuel in the vaporized fuel tank 42 flows into the surge tank 20 due to the intake negative pressure. Accordingly, the supply flow rate of the vaporized fuel increases as the intake negative pressure increases, within the maximum flow rate range determined according to the structure of the supply flow path and the like. Therefore, in the supply flow rate control, the intake negative pressure in the surge tank 20 (or the amount of fresh air that flows into the surge tank 20) is regulated by the throttle opening amount, and the supply flow rate of the vaporized fuel is controlled by this.

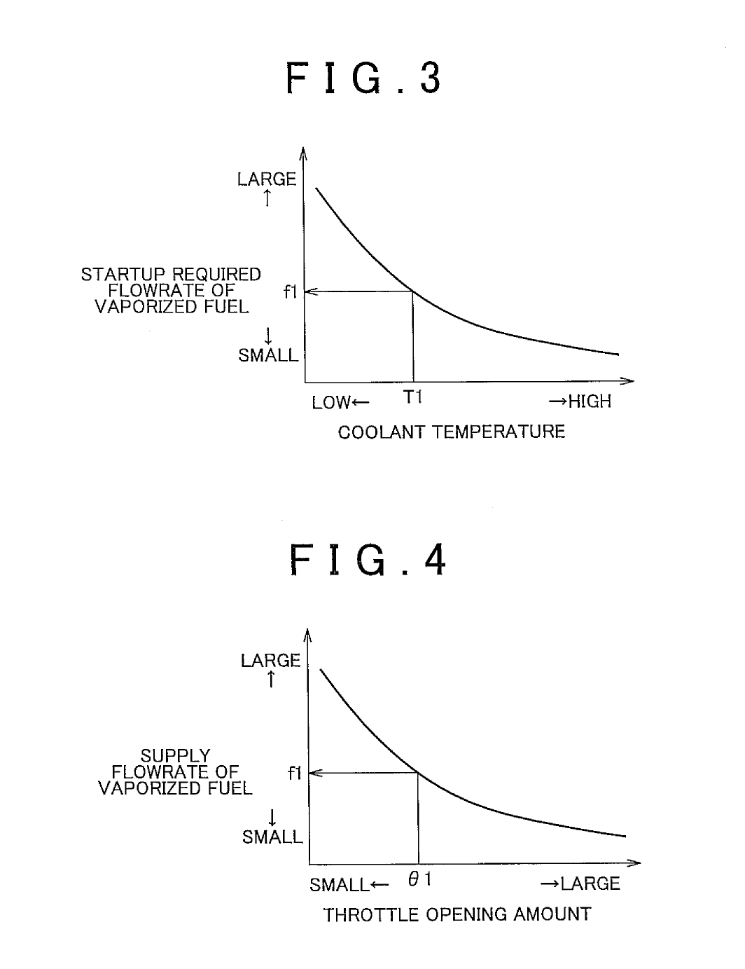

More specifically, in the supply flow rate control, a startup required flow rate of vaporized fuel is first calculated based on the temperature of the engine coolant. Here, the startup required flow rate is a flow rate of vaporized fuel that is required at startup, and may be defined, for example, as the minimum flow rate necessary to have an ignitable concentration of vaporized fuel flow into the cylinders. FIG. 3 is a characteristic line graph that shows the relationship between the coolant temperature at startup and the startup required flow rate of vaporized fuel. As shown in FIG. 3, the startup required flow rate has a characteristic of increasing as the coolant temperature at startup decreases. This characteristic is stored in advance in the ECU 70 as map data. Therefore, the ECU 70 is able to calculate a startup required flow rate appropriate for the temperature environment by referencing this map data based on the coolant temperature at startup. Incidentally, the startup required flow rate is also affected by the concentration of the vaporized fuel supplied at startup. Therefore, in this example embodiment, vaporized fuel is stored in the vaporized fuel tank 42 in a prescribed state near the saturated vapor pressure, and air inside the tank is discharged, as described above. Accordingly, the startup required flow rate is set assuming that vaporized fuel that has been stored in the prescribed state is supplied.

Next, in the supply flow rate control, the throttle opening amount is controlled to realize the startup required flow rate described above. FIG. 4 is a characteristic line graph showing the relationship between the supply flow rate of the vaporized fuel and the throttle opening amount. When the throttle opening amount is small, the inside of the surge tank 20 is that much closer to being closed. As a result, the intake negative pressure generated inside the surge tank 20 increases during cranking, and as a result, the flow rate of the vaporized fuel that flows out from the vaporized fuel tank 42 increases. Accordingly, the supply flow rate of the vaporized fuel has a characteristic of increasing as the throttle opening amount decreases, as shown in FIG. 4. This characteristic is stored in advance in the ECU 70 as map data. Therefore, the ECU 70 is able to calculate a target value of the throttle opening amount (i.e., a target opening amount) by referencing the map data based on the startup required flow rate.

The structure described above makes it possible to perform flow rate control such that the supply flow rate of the vaporized fuel comes to match the startup required flow rate, by driving the throttle valve 18 so that the throttle opening amount matches the target opening amount, when supplying vaporized fuel. As a result, startability can be ensured while the amount of vaporized fuel that is consumed can be appropriately suppressed. Accordingly, with this example embodiment, the flow rate of the vaporized fuel can be smoothly controlled using the existing throttle valve 18 even when a simple two-position switching type electromagnetic valve is used for both the vaporized fuel supply valve 48 and the air introduction valve 50. That is, it is not necessary to use an advanced flow rate control valve or the like, so the cost of the system can be reduced while performance can be improved.

Incidentally, in this control, the startup required flow rate and the target opening amount are calculated in order based on the coolant temperature at startup, by referencing the map data in FIGS. 3 and 4. However, as shown in FIGS. 3 and 4, if the coolant temperature at startup is coolant temperature T1, for example, the startup required flow rate f1 can be determined based on this coolant temperature T1, and further, the throttle opening amount 81 at which the startup required flow rate f1 becomes the supply flow rate can be determined. Therefore, in this invention, the map data in FIGS. 3 and 4 may be integrated and the throttle opening amount may be calculated based on the coolant temperature at startup.

[Specific Routine for Realizing the First Example Embodiment]

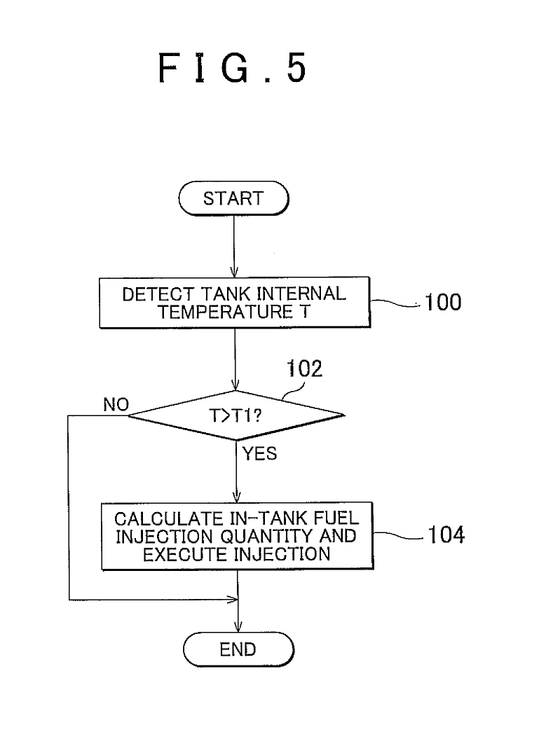

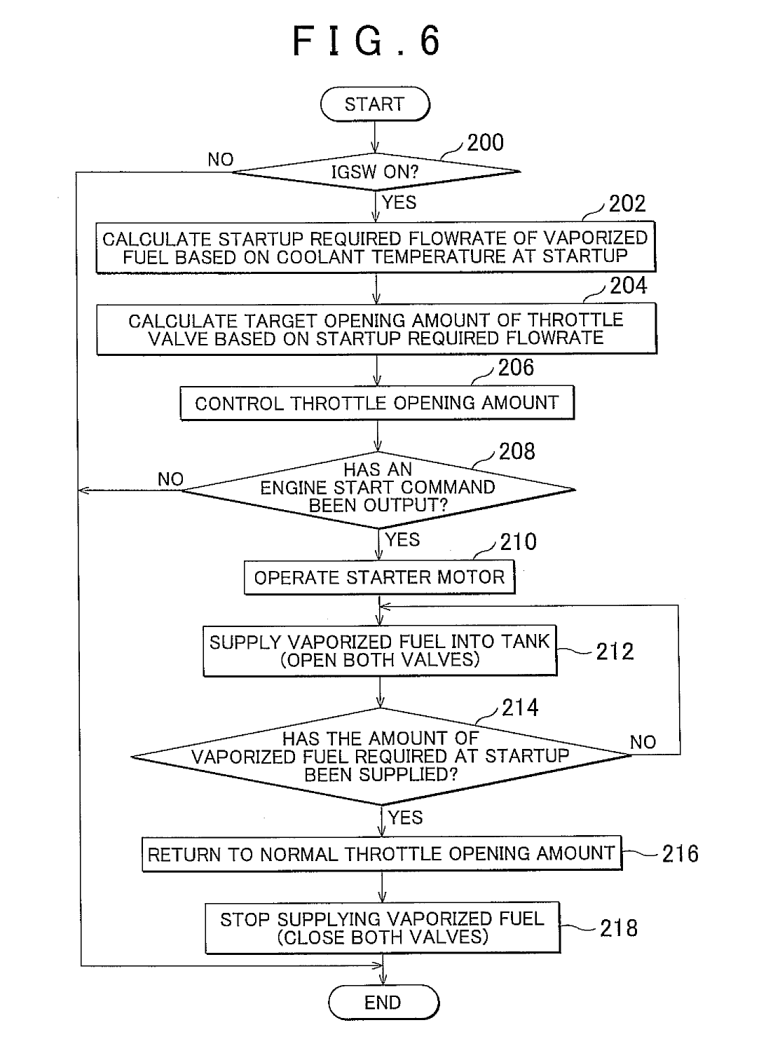

Next, a specific routine for realizing the control described above will be described with reference to FIGS. 5 and 6. First, FIG. 5 is a flowchart illustrating vaporized fuel production control executed by the ECU, in the first example embodiment of the invention. The routine in FIG. 5 is repeatedly executed while the engine is operating.

In the routine shown in FIG. 5, first, the temperature T in the vaporized fuel tank 42 is detected by the tank temperature sensor 64 (step 100), and it is determined whether this tank internal temperature T is higher than a determining temperature T1 (step 102). Here, the determining temperature T1 is a temperature that is set corresponding to the minimum value of the temperature at which vaporized fuel can be produced, and is a determining temperature for allowing fuel injection into the tank. If the determination in step 102 is yes, the temperature is such that fuel can easily vaporize, so the injection quantity of fuel to be injected into the vaporized fuel tank 42 is calculated and the in-tank injection valve 44 is driven while the vaporized fuel supply valve 48 and the air introduction valve 50 are closed (step 104). Accordingly, vaporized fuel is stored in the vaporized fuel tank 42.

Next, FIG. 6 is a flowchart illustrating vaporized fuel supply control executed by the ECU, in the first example embodiment of the invention. The routine shown in FIG. 6 is repeatedly executed while the engine is operating. In the routine shown in FIG. 6, first it is determined whether an ignition switch (IGSW) has been turned on (step 200). If the determination is yes, the coolant temperature at startup is detected by the coolant temperature sensor 58, and the startup required flow rate of vaporized fuel is calculated by referencing the map data in FIG. 3 based on this coolant temperature (step 202). Then the target opening amount of the throttle valve 18 is calculated referencing the map data in FIG. 4 based on the startup required flow rate (step 204). Next, the throttle valve 18 is driven to control the throttle opening amount to the target opening amount (step 206). Accordingly, the throttle opening amount is kept at the target opening amount before vaporized fuel starts to be supplied.

In the next step, it is determined whether an engine start command has been output. If the determination is yes, the starter motor 36 is operated (steps 208 and 210). Then while the intake negative pressure is generated in the surge tank 20 by cranking, the vaporized fuel supply valve 48 and the air introduction valve 50 are opened and vaporized fuel starts to be supplied (step 212). Also, while vaporized fuel is being supplied, the total supply amount of the vaporized fuel is calculated based on the supply flow rate of the vaporized fuel at the throttle opening amount (i.e., the target opening amount) set in step 206 and the period of time that has passed after the start of supply, for example. Then it is determined whether the amount of vaporized fuel required at startup has been supplied based on this total supply amount (step 214). If this determination is no, vaporized fuel continues to be supplied until the required amount of vaporized fuel is supplied.

Also, if the determination in step 214 is yes, the throttle opening amount is returned to the normal opening amount for startup control (step 216). Then the vaporized fuel supply valve 48 and the air introduction valve 50 are closed and vaporized fuel stops being supplied (step 218). After vaporized fuel stops being supplied, normal fuel injection control (i.e., startup injection control) described above is executed.

Incidentally, in the first example embodiment, steps 100 to 104 in FIG. 5 may be regarded as the vaporized fuel producing portion of the invention. Also, step 212 in FIG. 6 may be regarded as the vaporized fuel supplying portion of the invention. Step 206 may be regarded as the supply amount controlling portion of the invention, and steps 202 and 204 may be regarded as the target opening amount setting portion of the invention.

### Second Example Embodiment

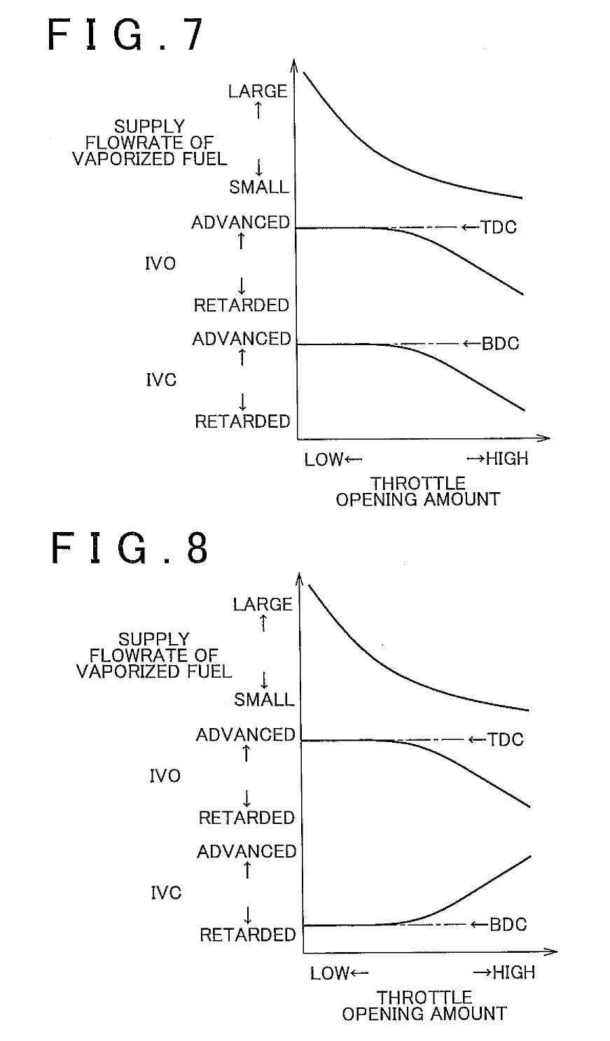

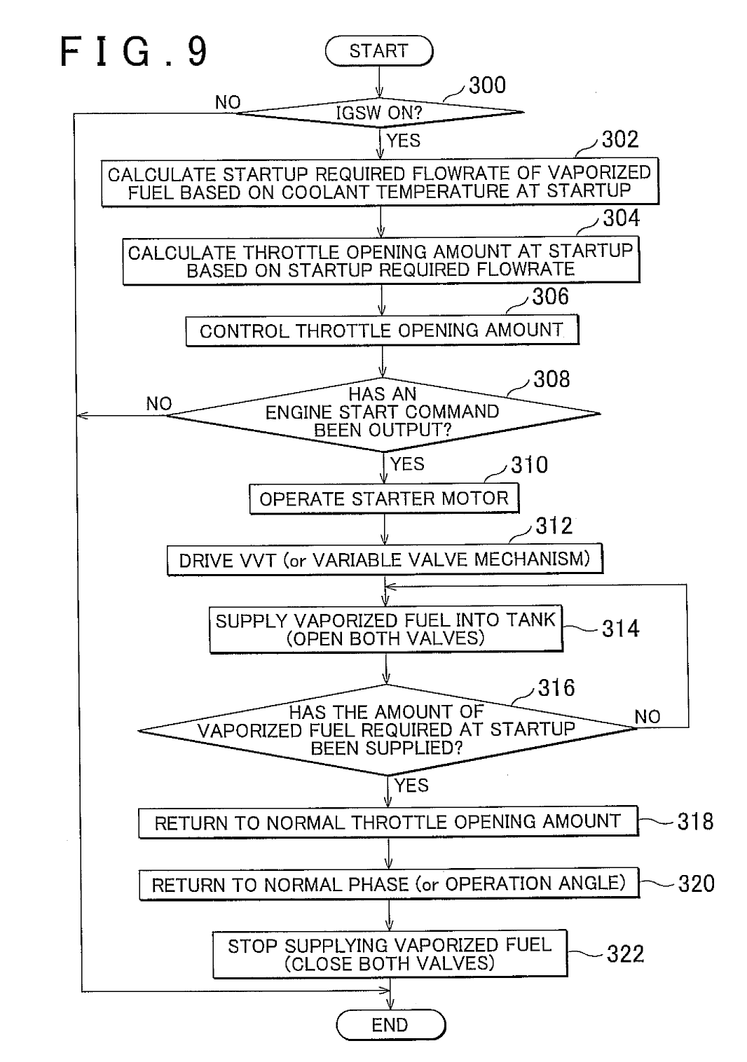

Next, a second example embodiment of the invention will be described with reference to FIGS. 7 and 9. This second example embodiment employs a structure and control (FIGS. 1, 2, and 5) that are almost the same as those of the first example embodiment described above, except that the operation angle and phase of the intake valve are controlled based on the throttle opening amount. Incidentally, constituent elements in this second example embodiment that are the same as those in the first example embodiment will be denoted by the same reference characters, and descriptions of those constituent elements will be omitted.

[Characteristics of the Second Example Embodiment]

In this example embodiment, the supply flow rate of the vaporized fuel is controlled based on the throttle opening amount, similar to the first example embodiment, but the amount of air that flows into the cylinders is controlled by changing the operation angle and the phase of the intake valve 32 based on the throttle opening amount. This structure is realized by the VVT 38 or the variable valve mechanism 40, so control when using the VVT 38 will be described first with reference to FIG. 7. FIG. 7 is a characteristic line graph showing the relationship between the throttle opening amount and the phase of the intake valve, in the second example embodiment of the invention.

As shown in FIG. 7, in this example embodiment, the phase (i.e., the IVO and the IVC) of the intake valve 32 is retarded by the VVT 38 as the throttle opening amount increases when vaporized fuel is supplied. When the throttle opening amount increases, the supply flow rate of the vaporized fuel can be decreased to a desired value, but the amount of air that flows into the cylinders will increase. At this time, the amount of air that flows into the cylinders can be suppressed by retarding the IVC from bottom-dead-center (BDC) on the intake stroke (hereinafter simply referred to as “intake BDC”). Also, when the throttle opening amount is decreased, the IVC is advanced toward intake BDC by that amount, such that the amount of intake air that flows into the cylinders can be maintained. That is, according to this example embodiment, even if the amount of air that flows into the cylinders fluctuates with the throttle opening amount control, this fluctuation can be compensated for by IVC control. Therefore, the amount of intake air that flows into the cylinders can be stabilized while controlling the supply flow rate of the vaporized fuel.

Also, in phase control by the VVT 38, if the IVC is retarded, the IVO also becomes retarded. Therefore, intake loss (i.e., pumping loss) is generated so that the temperature inside the cylinders can be increased. Accordingly, combustibility can be improved immediately after vaporized fuel stops being supplied (e.g., during the second or third combustion cycle when vaporized fuel stops being supplied after the first combustion cycle, for example).

Next, control when using the variable valve mechanism 40 will be described with reference to FIG. 8. FIG. 8 is a characteristic line graph showing the relationship between the throttle opening amount and the operation angle of the intake valve. As shown in the drawing, when using the variable valve mechanism 40, the operation angle of the intake valve 32 is decreased by the variable valve mechanism 40 as the throttle opening amount increases when vaporized fuel is supplied. As a result, when the throttle opening amount is large, the open period of the intake valve 32 becomes that much shorter so the amount of air that flows into the cylinders can be suppressed. Accordingly, almost the same effects as those obtained when the VVT 38 is used are also able to be obtained when the variable valve mechanism 40 is used.

[Specific Routine for Realizing the Second Example Embodiment]

Next, a specific routine for realizing the control described above will be described with reference to FIG. 9. FIG. 9 is a flowchart illustrating vaporized fuel supply control executed by the ECU, in the second example embodiment of the invention. The routine in FIG. 9 is repeatedly executed while the engine is operating, instead of the routine shown in FIG. 6 of the first example embodiment. Also, in the description below, a routine when the VVT 38 is used will be described first.

In the routine shown in FIG. 9, processes similar to those in steps 200 to 210 in FIG. 6 are first executed in steps 300 to 310. Next, in step 312, a target angle of the phase (i.e., the opening and closing timing) of the intake valve 32 is calculated with reference to the map data in FIG. 7 based on the throttle opening amount (i.e., the target opening amount) calculated in step 304. Then the VVT 38 is drivingly controlled so that the actual phase comes to match the target angle. Next, processes that are almost the same as those in steps 212 to 218 in FIG. 6 are executed in steps 314 to 322. However, in step 320, after vaporized fuel finishes being supplied, the VVT 38 is driven and the phase of the intake valve 32 is returned to the angle for normal startup control.

On the other hand, when the variable valve mechanism 40 is used, a target angle of the operation angle of the intake valve 32 is calculated referencing the map data in FIG. 8 based on the target opening amount of the throttle valve 18 in step 312. Then the variable valve mechanism 40 is drivingly controlled so that the actual operation angle comes to match the target angle. Also, in step 320, after the vaporized fuel finishes being supplied, the variable valve mechanism 40 is driven and the operation angle of the intake valve 32 is returned to the angle for normal startup control.

Incidentally, in this second example embodiment, step 314 in FIG. 9 may be regarded as the vaporized fuel supplying portion of the invention. Also, step 306 may be regarded as the supply amount controlling portion of the invention. Steps 302 and 304 may be regarded as the target opening amount setting portion of the invention. Furthermore, step 312 and FIGS. 7 and 8 may be regarded as the intake valve controlling portion of the invention.

Also, in the second example embodiment, examples when the VVT 38 and the variable valve mechanism 40 are used separately are described. However, the invention is not limited to this. That is, the VVT 38 and the variable valve mechanism 40 may also be driven together based on the throttle opening amount.

Meanwhile, in the example embodiments, the surge tank 20 is described as an example of a vaporized fuel supply portion with respect to the intake passage 12. However, the invention is not limited to this. That is, the vaporized fuel tank 42 may be connected to an appropriate portion of the intake passage 12, as long as it is downstream of the throttle valve 18, and vaporized fuel may be supplied to this portion.

Also, in the example embodiments, the vaporized fuel tank 42 is arranged in a location to which heat from the engine 10 can easily be conducted. However, the invention is not limited to this. That is, the vaporized fuel tank 42 may also be actively heated by heat generated by the engine 10. For example, a coolant conduit may be provided between the engine 10 and the vaporized fuel tank 42, and the vaporized fuel tank 42 may be heated by engine coolant. Also, a heat conducting member such as a heat pipe may be provided between the exhaust passage 14 and the vaporized fuel tank 42, and the vaporized fuel tank 42 may be heated by exhaust heat. These structures enable the saturated vapor pressure of the fuel inside the vaporized fuel tank 42 to be increased, thus enabling the amount of vaporized fuel that is able to be stored to be increased.

Also, in the example embodiments, the engine 10 includes both the intake port injection valve 26 and the in-cylinder injection valve 28. However, the invention is not limited to this. That is, the invention may also be applied to an internal combustion engine having only one of the injection valves 26 or 28 and not the other.

Moreover, in the example embodiments, the engine 10 uses alcohol fuel. However, the invention is not limited to this. That is, the invention may also be applied to an engine that uses normal gasoline or any one of a variety of fuels in which a component other than alcohol has been added to gasoline.

An outline of the control apparatus for an internal combustion engine according to the invention will be described below. The control apparatus for an internal combustion engine includes a fuel tank in which fuel is stored; a fuel injection valve that injects fuel in the fuel tank into an intake passage and/or a combustion chamber; a vaporized fuel tank that is connected to the intake passage and in which vaporized fuel that is the fuel that has been vaporized is stored; an in-tank fuel supplying portion that supplies fuel in the fuel tank to the vaporized fuel tank; a normally-closed vaporized fuel supply valve that opens and closes a connecting portion between the vaporized fuel tank and the intake passage; a normally-closed air introduction valve that introduces ambient air into the vaporized fuel tank and is provided in a position that enables the inside of the vaporized fuel tank to be communicated with a space outside the vaporized fuel tank; a throttle valve that is provided in the intake passage upstream of the vaporized fuel supply valve and adjusts a flow path area of the intake passage; a vaporized fuel producing portion that produces vaporized fuel in the vaporized fuel tank by driving the in-tank fuel supplying portion while the vaporized fuel supply valve and the air introduction valve are closed, while the internal combustion engine is operating; a vaporized fuel supplying portion that supplies vaporized fuel stored in the vaporized fuel tank while the internal combustion engine is operating to the intake passage by opening the vaporized fuel supply valve and the air introduction valve at startup of the internal combustion engine; and a supply amount controlling portion that controls a supply amount of vaporized fuel according to an opening amount of the throttle valve by driving the throttle valve when supplying vaporized fuel.

According to this control apparatus, vaporized fuel can be produced while the internal combustion engine is operating, and this vaporized fuel can be stored in a vaporized fuel tank using the natural decrease in pressure after the engine stops. Accordingly, it is not necessary to produce vaporized fuel at startup, so vaporized fuel can be immediately supplied into the cylinders even during a cold start. Also, when vaporized fuel is supplied, the throttle valve is driven and the amount of vaporized fuel that is supplied (i.e., the flow rate of vaporized fuel) can be controlled according to the throttle opening amount. As a result, startability can be ensured, while the amount of vaporized fuel that is consumed can be appropriately suppressed. Therefore, the amount of vaporized fuel that is supplied can be smoothly controlled using the existing throttle valve even when simple two-position switching type electromagnetic valves, for example, are used for the vaporized fuel supply valve and the air introduction valve. That is, the cost of the system can be reduced while performance can be improved.

The control apparatus described above may also include a target opening amount setting portion that variably sets a target opening amount of the throttle valve based on a temperature environment at startup or a startup required flow rate of vaporized fuel that is determined by the temperature environment. Also, the supply amount controlling portion may control the opening amount of the throttle valve to match the target opening amount.

According to the control apparatus described above, the target opening amount setting portion is able to appropriately set the target opening amount of the throttle valve based on the temperature environment at startup or the startup required flow rate of vaporized fuel that is determined by the temperature environment. As a result, startability can be ensured while the amount of vaporized fuel that is consumed can be appropriately suppressed.

The control apparatus described above may also include a variable intake valve portion that variably sets at least one parameter, from among a phase and an operation angle of an intake valve, and an intake valve controlling portion that controls the at least one parameter based on the opening amount of the throttle valve that is realized by the supply amount controlling portion, by driving the variable intake valve portion.

According to the control apparatus described above, the intake valve controlling portion is able to appropriately control the phase and/or the operation angle of the intake valve based on the opening amount of the throttle valve that is realized by the supply amount controlling portion. As a result, even if the amount of air that flows into the cylinders fluctuates with the control of the throttle opening amount, this fluctuation can be compensated for by the control of the phase and/or the operation angle. Therefore, the amount of intake air that flows into the cylinders can be stabilized while controlling the supply flow rate of the vaporized fuel.

In the control apparatus described above, the intake valve controlling portion may retard the phase of the intake valve as the opening amount of the throttle valve increases.

According to the control apparatus described above, the intake valve controlling portion is able to retard the phase of the intake valve as the opening amount of the throttle valve increases. As a result, when the throttle opening amount is increased, the closing timing of the intake valve can be retarded from intake BDC, such that the amount of air that flows into the cylinders can be suppressed.

In the control apparatus described above, the intake valve controlling portion may decrease the operation angle of the intake valve as the opening amount of the throttle valve increases.

According to the control apparatus described above, the intake valve controlling portion is able to reduce the operation angle of the intake valve as the opening amount of the throttle valve increases. As a result, when the throttle opening amount is increased, the open period of the intake valve is shortened so the amount of air that flows into the cylinders can be suppressed.

In the control apparatus described above, alcohol fuel may be used as the fuel.

According to the control apparatus described above, even when an alcohol fuel that does not easily vaporize at low temperatures is used, startability can be improved by storing vaporized fuel in the vaporized fuel tank while the internal combustion engine is operating, and supplying this vaporized fuel at startup.

While the invention has been described with reference to example embodiments thereof, it is to be understood that the invention is not limited to the described embodiments or constructions. The invention is intended to cover various modifications and equivalent arrangements. In addition, while the various elements of the disclosed invention are shown in various example combinations and configurations, other combinations and configurations, including more, less or only a single element, are also within the scope of the appended claims.

What is claimed is:

1. A control apparatus for an internal combustion engine, comprising:
a fuel tank in which fuel is stored;
a fuel injection valve that injects fuel in the fuel tank into an intake passage and/or a combustion chamber;
a vaporized fuel tank that is connected to the intake passage and in which vaporized fuel that is the fuel that has been vaporized is stored;
an in-tank fuel supplying portion that supplies fuel in the fuel tank to the vaporized fuel tank;
a normally-closed vaporized fuel supply valve that opens and closes a connecting portion between the vaporized fuel tank and the intake passage;
a normally-closed air introduction valve that introduces ambient air into the vaporized fuel tank and is provided in a position that enables the inside of the vaporized fuel tank to be communicated with a space outside the vaporized fuel tank;
a throttle valve that is provided in the intake passage upstream of the vaporized fuel supply valve and adjusts a flow path area of the intake passage;
a vaporized fuel producing portion that produces vaporized fuel in the vaporized fuel tank by driving the in-tank fuel supplying portion while the vaporized fuel supply valve and the air introduction valve are closed, while the internal combustion engine is operating;
a vaporized fuel supplying portion that supplies vaporized fuel stored in the vaporized fuel tank while the internal combustion engine is operating to the intake passage by opening the vaporized fuel supply valve and the air introduction valve at startup of the internal combustion engine; and
a supply amount controlling portion that controls a supply amount of vaporized fuel according to an opening amount of the throttle valve by driving the throttle valve when supplying vaporized fuel.

2. The control apparatus according to claim 1, further comprising:
a target opening amount setting portion that variably sets a target opening amount of the throttle valve based on a temperature environment at startup or a startup required flow rate of vaporized fuel that is determined by the temperature environment,
wherein the supply amount controlling portion controls the opening amount of the throttle valve to match the target opening amount.

3. The control apparatus according to claim 1, further comprising:
a variable intake valve portion that variably sets at least one parameter, from among a phase and an operation angle of an intake valve; and
an intake valve controlling portion that controls the at least one parameter based on the opening amount of the throttle valve that is realized by the supply amount controlling portion, by driving the variable intake valve portion.

4. The control apparatus according to claim 3, wherein the intake valve controlling portion retards the phase of the intake valve as the opening amount of the throttle valve increases.

5. The control apparatus according to claim 3, wherein the intake valve controlling portion decreases the operation angle of the intake valve as the opening amount of the throttle valve increases.

6. The control apparatus according to claim 1, wherein alcohol fuel is used as the fuel.

7. A control apparatus for an internal combustion engine system, comprising:
a fuel tank in which fuel is stored;
a vaporized fuel tank that is supplied with fuel from the fuel tank;
a fuel supplying portion that supplies fuel in the fuel tank to the vaporized fuel tank;
an intake passage that is a passage that supplies a mixture of fuel and air to an internal combustion engine, and that is connected to the vaporized fuel tank;
a vaporized fuel supply valve that opens and closes communication between the vaporized fuel tank and the intake passage;
an air introduction valve that introduces ambient air into the vaporized fuel tank and is provided in a position that enables the inside of the vaporized fuel tank to be communicated with a space outside the vaporized fuel tank;
a throttle valve that is provided in the intake passage upstream of the vaporized fuel supply valve and adjusts a flow path area of the intake passage;
a vaporized fuel producing portion that produces vaporized fuel in the vaporized fuel tank by operating the fuel supplying portion while the vaporized fuel supply valve and the air introduction valve are closed, while the internal combustion engine is operating;
a vaporized fuel supplying portion that supplies vaporized fuel stored in the vaporized fuel tank while the internal combustion engine is operating to the intake passage by opening the vaporized fuel supply valve and the air introduction valve at startup of the internal combustion engine; and
a supply amount controlling portion that controls a supply amount of vaporized fuel according to an opening amount of the throttle valve by driving the throttle valve when supplying vaporized fuel.

8. A control method for an internal combustion engine system that includes a fuel tank in which fuel is stored; a vaporized fuel tank that is supplied with fuel from the fuel tank; a fuel supplying portion that supplies fuel in the fuel tank to the vaporized fuel tank;
an intake passage that is a passage that supplies a mixture of fuel and air to an internal combustion engine, and that is connected to the vaporized fuel tank; a vaporized fuel supply valve that opens and closes communication between the vaporized fuel tank and the intake passage; an air introduction valve that introduces ambient air into the vaporized fuel tank and is provided in a position that enables the inside of the vaporized fuel tank to be communicated with a space outside the vaporized fuel tank; and a throttle valve that is provided in the intake passage upstream of the vaporized fuel supply valve and adjusts a flow path area of the intake passage, the control method comprising:
producing vaporized fuel in the vaporized fuel tank by operating the fuel supplying portion while the vaporized fuel supply valve and the air introduction valve are closed, while the internal combustion engine is operating;
supplying vaporized fuel stored in the vaporized fuel tank while the internal combustion engine is operating to the intake passage by opening the vaporized fuel supply valve and the air introduction valve at startup of the internal combustion engine; and
controlling a supply amount of vaporized fuel according to an opening amount of the throttle valve by driving the throttle valve when supplying vaporized fuel.
